(19) United States
(12) Patent Application Publication
(10) Pub. No.: US 2020/0252516 A1
(43) Pub. Date: Aug. 6, 2020

(54) IMAGE FORMING APPARATUS

(71) Applicant: KYOCERA Document Solutions Inc., Osaka (JP)

(72) Inventor: Mizue KADOBAYASHI, Osaka-shi (JP)

(73) Assignee: KYOCERA Document Solutions Inc., Osaka (JP)

(21) Appl. No.: 16/773,029

(22) Filed: Jan. 27, 2020

(30) Foreign Application Priority Data
Feb. 6, 2019 (JP) 2019-019547

(51) Int. Cl. H04N 1/00

(52) U.S. Cl. CPC H04N 1/00904; H04N 1/00896; H04N 1/00639

(57) ABSTRACT

A post-processing device attaches sheets of paper together using one or more staples. A power management section shifts from a normal mode to a power saving mode when no operation exists within first time. A system controller predicts whether possibility of using the one or more staples will be high or low based on predetermined reference including a print pattern of a print job and processing ability of the post-processing device. The system controller causes the power management section to switch the first time with second time longer than the first time when determining that the possibility of using the one or more staples will be high, and does not switch the first time with the second time when determining that the possibility of using the one or more staples will be low.

### INCORPORATION BY REFERENCE

The present application claims priority under 35 U.S.C. § 119 to Japanese Patent Application No. 2019-019547, filed on Feb. 6, 2019. The contents of this application are incorporated herein by reference in their entirety.

### BACKGROUND

The present disclosure relates to an image forming apparatus including a post-processing device.

For example, a power saving mode is installed in an image forming apparatus such as a multifunction peripheral (MFP) provided with a printing function, a copy function, a FAX function, and a data transmitting and receiving function via a network in order to promote energy conservation—achieve high energy savings. Here, the power saving mode includes a low power mode and a sleep mode. The low power mode is a mode entered from a normal mode when no operation exists within for example constant time in the normal mode. The sleep mode is a mode entered from the low power mode further when no operation exists within constant time in the low power mode. The sleep mode achieves higher energy savings than the low power mode does. Note that the apparatus enables a user to omit the low power mode by user setting.

Some among such types of image forming apparatuses allow a post-processing device called a finisher to be added thereto. Here, the post-processing device is provided with a stapler mechanism for stapling sheets of printed paper together, a punch mechanism for punching holes in one or more sheets of printed paper, and the like. Note that two types of post-processing devices are available for these image forming apparatuses. One type is a simple inner type that allows the post-processing device to be installed in a compatible image forming apparatus, and the other type is an outer type that allows the post-processing device to be installed next to an image forming apparatus.

The inner type post-processing device is often configured to receive power supplied from the image forming apparatus in order to simplify power cable wiring in particular. The image forming apparatus equipped with the inner type post-processing device enters the sleep mode, and then stops supplying power to the post-processing device. It is therefore possible to achieve high energy savings.

It is however conceivable that while the post-processing device is in operation, the image forming apparatus enters the sleep mode to stop supplying power therefrom to the post-processing device, thereby forcibly interrupting a stapling operation by the post-processing device.

That is, the stapling to be performed by the inner type post-processing device requires a user to separate printed matter into batches to separately insert each of the separated batches (i.e., sheets of paper) into an insertion slot of the post-processing device. Here, the number of copies (batches) to be stapled being larger takes more time to separate the printed matter into batches. Accordingly, the image forming apparatus entering the sleep mode during the stapling operation may make the post-processing device unusable. This requires the user to operate a start button or the like of the image forming apparatus to shift the image forming apparatus from the sleep mode to the normal mode. It however takes some time to return from the sleep mode to the normal mode. This causes the user to wait until the image forming apparatus returns to the normal mode.

To eliminate such inconvenience, an image forming apparatus incorporating an inner type stapler unit below has been proposed. That is, the image forming apparatus includes the stapler unit, a data input section, a printing unit, a power supply, and a controller. The stapler unit includes a stapler mechanism that puts staples into sheets of paper (batch), and a drive source that drives the stapler mechanism. The data input section allows print data used for printing to be entered therein. The printing unit performs a print job based on the print data. The power supply supplies power to the stapler unit. The controller causes the power supply to supply the power to the stapler unit until at least waiting time has elapsed from the end of the print job. The controller further starts measuring the elapsed time since the end of the print job, and then causes the power supply to stop supplying the power to the stapler unit when the elapsed time reaches the waiting time. The controller then predicts whether or not printed matter on which the print job has been executed will be stapled together. When predicting that the printed matter will not be stapled together, the controller sets the waiting time to first time. When predicting that the printed matter will be stapled together, the controller sets the waiting time to second time longer than the first time.

### SUMMARY

An image forming apparatus according to an aspect of the present disclosure includes a post-processing device, a power management section, and a system controller. The post-processing device attaches sheets of paper together using one or more staples. The post-processing device is of a manual type. The power management section supplies power to the post-processing device. The power management section shifts from a normal mode to a power saving mode when no operation exists within first time. The system controller predicts whether possibility of using the one or more staples will be high or low based on whether or not at least one of two factors satisfies a predetermined condition. Here, the two factors include a print pattern of a print job and processing ability of the post-processing device. When predicting that the possibility of using the one or more staples will be high, the system controller causes the power management section to switch the first time with second time longer than the first time. When predicting that the possibility of using the one or more staples will be low, the system controller does not switch the first time with the second time.

### BRIEF DESCRIPTION OF THE DRAWINGS

FIG. 1 illustrates an MFP applied as an image forming apparatus according to an embodiment of the present disclosure.

FIG. 2A is a first figure illustrating a configuration example of the MFP, a post-processing device, and a user terminal in FIG. 1.

FIG. 2B is a second figure illustrating another configuration example of the MFP, the post-processing device, and the user terminal in FIG. 1.

FIG. 3 is a sleep transition time extension judgment table to which a system controller in FIG. 2B refers.

FIG. 4A illustrates a first half stage of a flowchart illustrating a sleep transition process in the MFP side in FIG. 1.

FIG. 4B illustrates a second half stage of the flowchart illustrating the sleep transition process in the MFP in FIG. 1.

### DETAILED DESCRIPTION

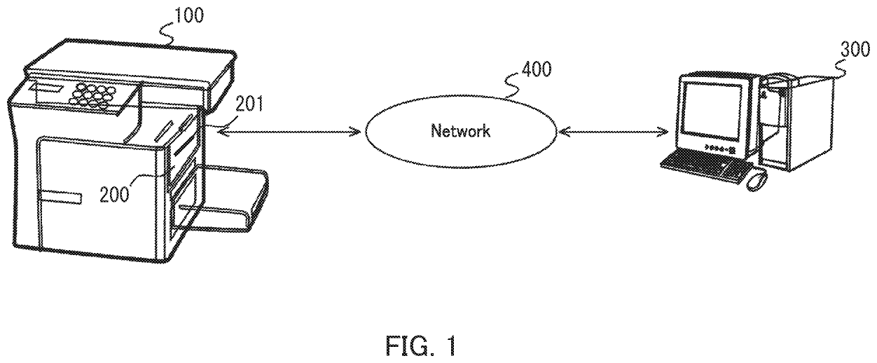

An image forming apparatus according to an embodiment of the present disclosure will hereinafter be described with reference to FIGS. 1 to 4B. Note that the image forming apparatus according to an aspect of the present disclosure is applied to a multifunction peripheral (MFP) including a printing function, a copy function, a FAX function, and a data transmitting and receiving function via a network in description below.

As illustrated in FIG. 1, it is assumed that the MFP 100 is connected to a user terminal 300 via a network 400 such as an internal local area network (LAN). Note that the MFP 100 and the user terminal 300 are not limited to one each as illustrated in the figure, but may be two or more each. This enables the user terminal 300 to instruct the MFP 100 to perform printing by transmitting a print job to the MFP 100 via the network 400.

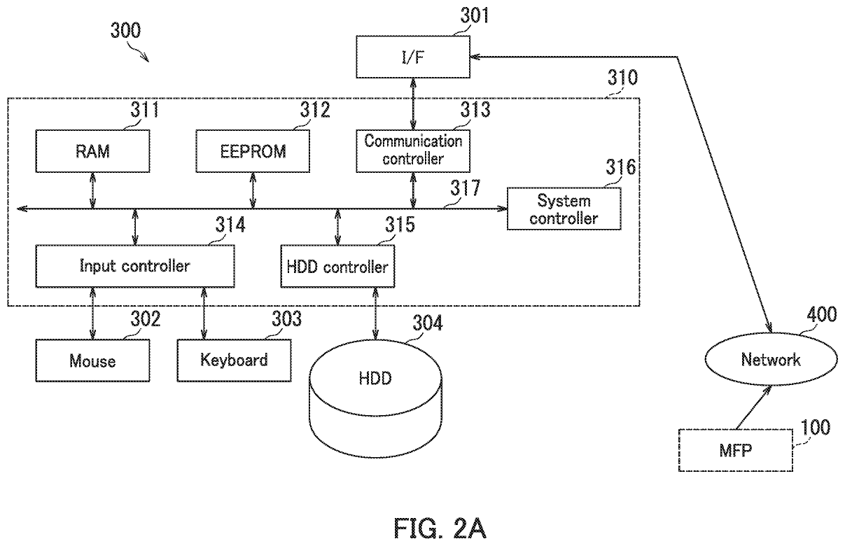

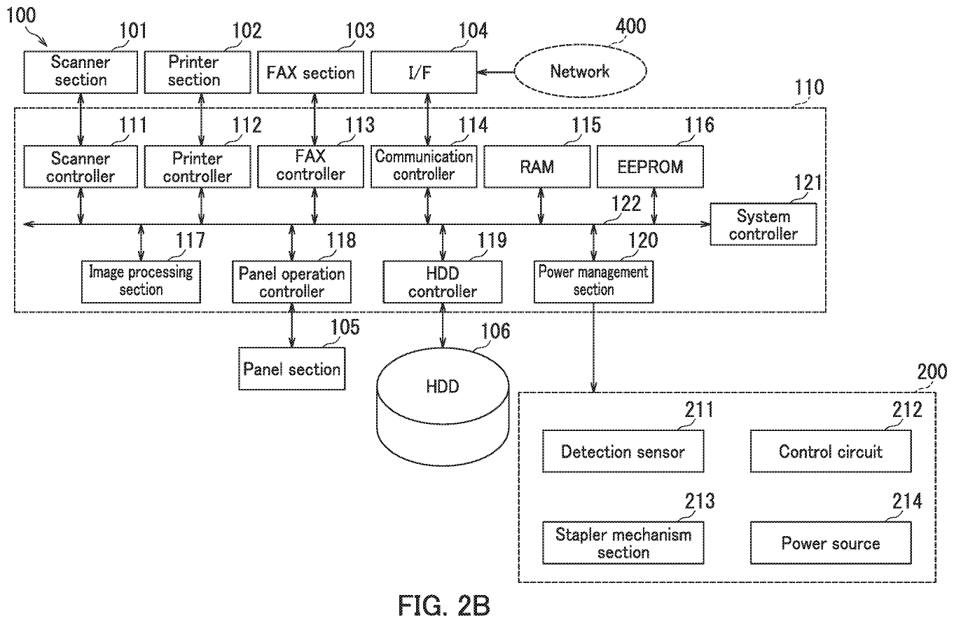

Although the MFP 100 will be described in detail later, the MFP 100 is provided with an inner type post-processing device 200. The post-processing device 200 includes a stapler mechanism that attaches unillustrated sheets of printed paper together using one or more staples. Note that the post-processing device 200 may include a punch mechanism that punches one or more holes in a sheet of printed paper. In addition, the post-processing device 200 is of a manual type, and includes an insertion slot 201 for sheets of paper. In order to staple sheets of paper together, when the sheets of paper are inserted into the insertion slot 201, a detection sensor 211 depicted in FIG. 2B to be described later detects the sheets of paper, and a stapler mechanism section 213 then staples the sheets of paper together. The post-processing device 200 is energized by power supplied from the MFP 100. Note that the post-processing device 200 may be energized by power supplied from an external power supply.

The MFP 100 is provided with a power saving mode in order to promote energy conservation—achieve high energy savings. Here, the power saving mode includes a low power mode and a sleep mode. The low power mode is a mode entered from a normal mode when no operation exists within for example constant time in the normal mode. The sleep mode is a mode entered from the low power mode further when no operation exists within constant time in the low power mode. The sleep mode achieves higher energy savings than the low power mode does. In the present embodiment, for convenience of explanation, it is assumed that the low power mode is set to be omitted. Waiting time for shifting from a normal mode to the sleep mode is set to 1 minute for convenience of explanation.

A configuration example of the MFP 100, the post-processing device 200, the user terminal 300 and the like will next be described with reference to FIGS. 2A and 2B. The MFP 100 includes a scanner section 101, a printer section 102, a facsimile (FAX) section 103, an interface (I/F) 104, a panel section 105, a hard disk drive (HDD) 106, and a controller 110 that controls respective operations of these components.

The scanner section 101 is a device that converts an image of an unillustrated document into digital image date to be entered into the controller 110. Here, the document is scanned by an unillustrated image sensor. The printer section 102 is a device that prints an image on an unillustrated sheet of paper based on print data provided from the controller 110. The FAX section 103 is a device that transmits data provided from the controller 110 to a facsimile machine of a party via a telephone line, and also receives data from a facsimile machine of a party to enter the received data into the controller 110.

The I/F 104 performs communication with a different MFP 100 and the user terminal 300 via the network 400. Note that the I/F 104 may perform communication with unillustrated content server, web server, or the like. The panel section 105 is a device that performs display for the printing function, the copy function, the FAX function, and the data transmitting and receiving function of the MFP 100, the network 400, and various settings. The HDD 106 is a device that stores therein an application program for providing various functions of the MFP 100, and the like. The HDD 106 further includes a user box that stores therein for example print jobs received from the user terminal 300.

The controller 110 is a processor that executes an image forming program, a control program, and an application program such as a certification program to control an entire operation of the MFP 100. The controller 110 includes a scanner controller ill, a printer controller 112, a FAX controller 113, a communication controller 114, random access memory (RAM) 115, electrically erasable programmable read-only memory (EEPROM) 116, an image processing section 117, a panel operation controller 118, an HDD controller 119, a power management section 120, and a system controller 121. These components are connected to a data bus 122.

The scanner controller 111 controls a reading operation of the scanner section 101. The printer controller 112 controls a print operation of the printer section 102. The FAX controller 113 controls data transmitting and receiving operations by the FAX section 103. The communication controller 114 controls, through the I/F 104, transmitting and receiving of data and the like via the network 400.

The RAM 115 is work memory used for executing programs. The RAM 115 also stores therein print data on which image processing by the image processing section 117 has been performed. The EEPROM 116 stores therein the control program used for checking respective operations of components to be controlled by the controller 110. The EEPROM 116 further stores therein firmware including version data used for operating the scanner section 101, the printer section 102, the FAX section 103, the I/F (interface) 104, the panel section 105, the HDD 106, and the like.

The image processing section 117 performs image processing (rasterizing) of image data read by the scanner section 101. The image processing section 117 further performs image processing (rasterizing) according to a print job received from for example the user terminal 300. The image processing section 117 further performs image processing (rasterizing) of data to be printed, which is registered in the user box of the HDD 106. Note that the system controller 121 temporarily stores, in the RAM 115, the print data on which image processing by the image processing section 117 has been performed.

The power management section 120 manages power to be supplied to the MFP 100 and the post-processing device 200. That is, the power management section 120 has the power saving mode. Here, the power saving mode is for example a mode shifted from the normal mode to the sleep mode when no operation exists within constant time (e.g. one minute) in the normal mode. When entering the sleep mode, the power management section 120 stops supplying power to a print mechanism section having an unillustrated photosensitive drum and the like in the printer section 102, pan of the panel section 105 of the MFP 100, and the post-processing device 200. In addition, for example when a touch operation is performed on the panel section 105, the power management section 120 shifts from the sleep mode to the normal mode to resume supplying power.

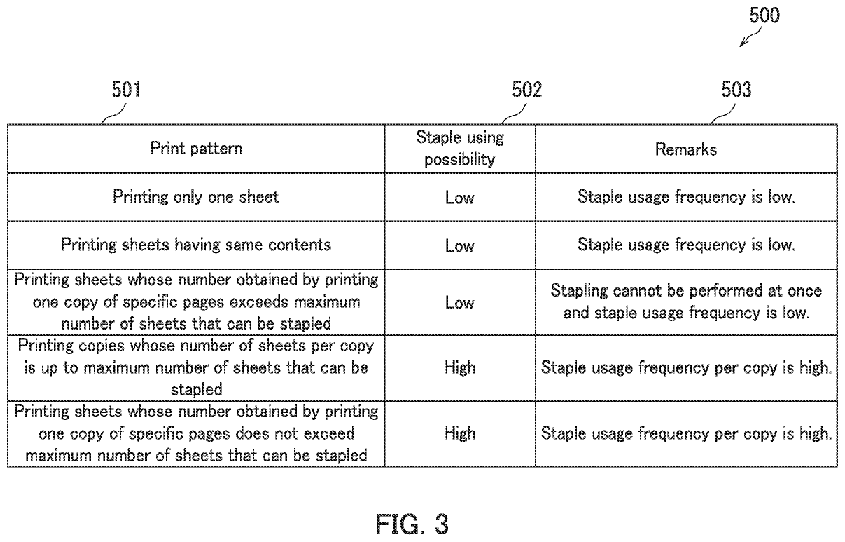

The system controller 121 controls cooperative operations between the components. Although the system controller 121 will be described in detail later, the system controller 121 controls the power management section 120 by predicting possibility of using the one or more staples based on a print pattern represented by a print job, processing ability of the post-processing device 200, and the like. Hereinafter, the possibility of using the one or more staples is also simply referred to “staple using possibility”. Note that the print pattern includes the number of copies, the number of sheets to be printed, and the like. When predicting the staple using possibility in the post-processing device 200, the system controller 121 refers to a sleep transition time extension judgment table 500 depicted by FIG. 3 to be described later. Hereinafter, the sleep transition time extension judgment table 500 is also simply referred to a “table 500”.

The post-processing device 200 includes the detection sensor 211, a control circuit 212, the stapler mechanism section 213, and a power source 214. The detection sensor 211 detects whether or not unillustrated sheets of paper are inserted into the insertion slot 201 illustrated in FIG. 1. Examples of the detection sensor 211 include an optical sensor and a mechanical sensor. When the detection sensor 211 detects sheets of paper inserted into the insertion slot 201, the control circuit 212 controls the stapler mechanism section 213. The stapler mechanism section 213 includes, but not illustrated, a magazine containing staples, a pushing section that pushes one or more staples in the magazine into sheets of paper, and a bending base that bends respective tip ends of the one or more staples pushed thereinto toward the sheets of paper. The power source 214 supplies the detection sensor 211, the control circuit 212, and the stapler mechanism section 213 with power supplied from the MFP 100. Note that the power source 214 may receive power supplied from an outside. Note that the post-processing device 200 may include a punch mechanism that punches holes in sheets of printed paper, and the like.

The user terminal 300 includes an I/F 301, a mouse 302, a keyboard 303, an HDD 304, and a controller 310 that controls respective operations of these components. The I/F 301 is connected to the MFP 100 via the network 400. The mouse 302 is used for an operation for specifying a character entry position, and the like. The keyboard 303 is used for entering characters and the like. The HDD 304 stores therein one or more print jobs, and the like.

The controller 310 is a processor that executes the control program or the like to control an entire operation of the user terminal 300. The controller 310 includes RAM 311, EEPROM 312, a communication controller 313, an input controller 314, an HDD controller 315, and a system controller 316. These components are connected to a data bus 317.

The RAM 311 is work memory used for executing programs. The EEPROM 312 stores therein the control program used for checking respective operations of components to be controlled by the controller 310. The communication controller 313 controls, through the I/F 301, transmitting and receiving of data and the like via the network 400. The input controller 314 controls respective input operations of the mouse 302 and the keyboard 303. The system controller 316 transmits a print job and the like to the MFP 100 via the communication controller 313.

An example of the table 500 to which the system controller 121 of the MFP 100 refers will next be described with reference to FIG. 3. Items registered in the table 500 include a print pattern represented by a print job, a criterion for the staple using possibility based on processing ability of the post-processing device 200, and the like. It is assumed that, in the post-processing device 200, the maximum number of sheets that can be stapled at one time is for example 10 for convenience of explanation.

The table 500 includes an item 501 representing a print pattern based on job contents for each row, an item 502 representing staple using possibility for each row, and an item 503 representing remarks for each row. Content examples of print pattern registered in the item 501 include “printing only one sheet”, “printing sheets having the same contents”, “printing sheets whose number obtained by printing one copy of specific pages exceeds the maximum number of sheets that can be stapled”, “printing copies whose number of sheets per copy is up to the maximum number of sheets that can be stapled”, and “printing sheets whose number obtained by printing one copy of specific pages does not exceed the maximum number of sheets that can be stapled”.

The system controller 121 predicts whether staple using possibility will be high or low based on whether or not at least one of two factors satisfies a predetermined condition. Here, the two factors include a print pattern of a print job and processing ability of the post-processing device. Examples of the predetermined condition include a print pattern corresponding to the “printing only one sheet”. Specifically, when the print pattern of the item 501 satisfies a condition of the “printing only one sheet”, the system controller 121 determines that the staple using possibility in the item 502 is “Low”. This is because a staple usage frequency is low in the case of the “printing only one sheet” as depicted in corresponding remarks in the item 503. In this print pattern, the system controller 121 confirms that the staple using possibility in the item 502 is “Low”, thereby predicting that the staple using possibility will be “Low”. The system controller 121 consequently determines that sleep transition time need not be extended.

Examples of the predetermined condition further include a print pattern corresponding to the “printing sheets having the same contents”. Specifically, when the print pattern satisfies a condition of the “printing sheets having the same contents” in the item 501, the system controller 121 determines that the staple using possibility in the item 502 is “Low”. This is because the staple usage frequency is low in the case of the “printing sheets having the same contents” as depicted in corresponding remarks in the item 503. In this print pattern, the system controller 121 confirms that the staple using possibility in the item 502 is “Low”, thereby predicting that the staple using possibility will be “Low”. The system controller 121 consequently determines that sleep transition time need not be extended. Here, it is assumed that, as an example of the “printing sheets having the same contents”, the number of printed pages is 1 and the number of copies is 5.

Examples of the predetermined condition further include a print pattern corresponding to the “printing sheets whose number obtained by printing one copy of specific pages exceeds the maximum number of sheets that can be stapled”. Specifically, in the case of “printing sheets whose number obtained by printing one copy of specific pages exceeds the maximum number of sheets that can be stapled” in the item 501, the system controller 121 determines that the staple using possibility in the item 502 is “Low”. This is because in the case of the “printing sheets whose number obtained by printing one copy of specific pages exceeds the maximum number of sheets that can be stapled” as depicted in corresponding remarks in the item 503, the sheets of paper cannot be stapled together at once and the staple usage frequency is low. In this print pattern, the system controller 121 confirms that the staple using possibility in the item 502 is “Low”, thereby predicting that the staple using possibility will be “Low”. The system controller 121 consequently determines that sleep transition time need not be extended. Here, it is assumed that, as an example of the “printing sheets whose number obtained by printing one copy of specific pages exceeds the maximum number of sheets that can be stapled”, the number of printed pages is 15 and the number of copies is 3.

Examples of the predetermined condition further include a print pattern corresponding to the “printing copies whose number of sheets per copy is up to the maximum number of sheets that can be stapled”. Specifically, in the case of the “printing copies whose number of sheets per copy is up to the maximum number of sheets that can be stapled” in the item 501, the system controller 121 determines that the staple using possibility in the item 502 is “High”. This is because in the case of the “printing copies whose number of sheets per copy is up to the maximum number of sheets that can be stapled” as depicted in corresponding remarks in the item 503, the staple using possibility per copy is high. In this print pattern, the system controller 121 confirms that the staple using possibility in the item 502 is “High”, thereby predicting that the staple using possibility will be “High”. The system controller 121 consequently determines that sleep transition time need to be extended. Here, it is assumed that, as an example of the “printing copies whose number of sheets per copy is up to the maximum number of sheets that can be stapled”, the number of printed pages is 10 or less and the number of copies is 5.

Examples of the predetermined condition further include a print pattern corresponding to the “printing sheets whose number obtained by printing one copy of specific pages does not exceed the maximum number of sheets that can be stapled”. Specifically, in the case of “printing sheets whose number obtained by printing one copy of specific pages does not exceed the maximum number of sheets that can be stapled” in the item 501, the system controller 121 determines that the staple using possibility in the item 502 is “High”. This is because in the case of the “printing sheets whose number obtained by printing one copy of specific pages does not exceed the maximum number of sheets that can be stapled” as depicted in corresponding remarks in the item 503, the staple usage frequency per copy is high. In this print pattern, the system controller 121 confirms that the staple using possibility in the item 502 is “High”, thereby predicting that the staple using possibility will be “High”. The system controller 121 consequently determines that sleep transition time need to be extended. Here, it is assumed that, as an example of “printing sheets whose number obtained by printing one copy of specific pages does not exceed the maximum number of sheets that can be stapled”, when the number of printed pages is 10, three copies of pages 1 to 5 are printed, and five copies of pages 6 to 10.

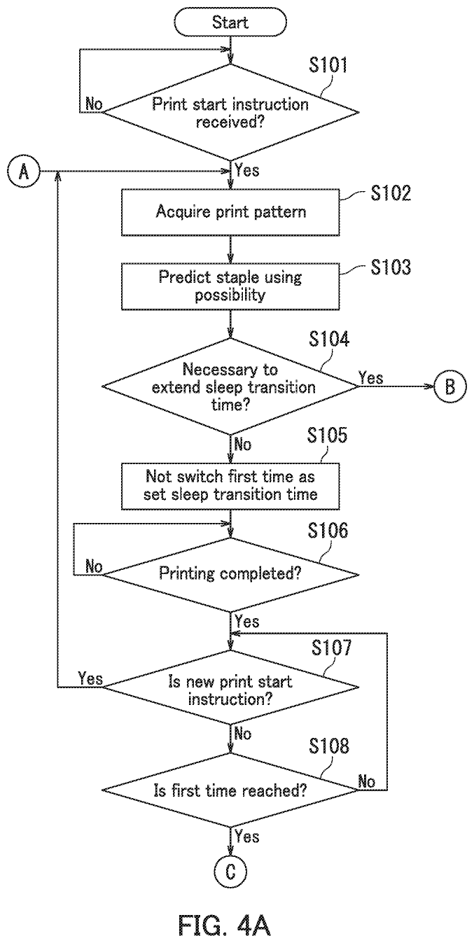

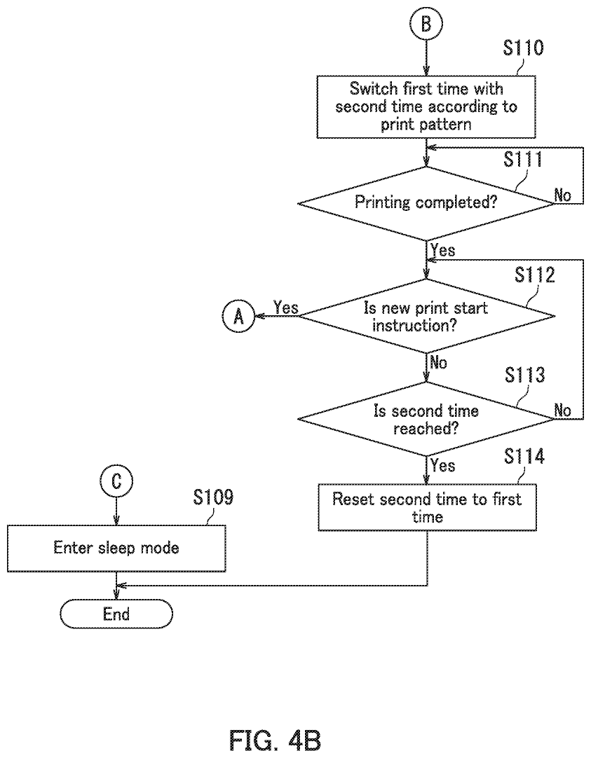

A sleep transition process in the MFP 100 will next be described with reference to FIGS. 4A and 4B. Note that a process executed by the MFP 100 that has received a print job including a print instruction from the user terminal 300 will be described below. In the description below, it is also assumed that the time to shift to the sleep mode from the normal mode when no operation exists within the constant time in the normal mode is set as first time. In the description, it is assumed that the first time is for example one minute.

(Step S101)

The system controller 121 determines whether or not to receive a print start instruction.

In this case, the system controller 121 determines that the print start instruction has not been received when no notification (first notification) exists (Step S101: No). Here, the first notification indicates that a print job including a print instruction from the communication controller 114 has been received.

In contrast, the system controller 121 determines that the print start instruction has been received when the first notification (including that the print job including the print instruction from the communication controller 114 has been received) exists (Step S101: Yes). The process then proceeds to Step S102.

Note that when determining that the print start instruction has been received, the system controller 121 instructs the image processing section 117 to perform image processing of print data of the print job, and then instructs the printer controller 112 to perform print processing based on data on which the image processing by the image processing section 117 has been performed.

(Step S102)

The system controller 121 acquires a print pattern.

In this case, the system controller 121 acquires the print pattern from the print job received by the communication controller 114. Here, the print pattern represents the number of pages and the number of copies (when the number of copies is specified) to be printed. The process then proceeds to Step S103.

(Step S103)

The system controller 121 predicts staple using possibility in this case.

That is, the system controller 121 refers to the table 500 in FIG. 3, and predicts the staple using possibility by any of items (1) to (5) below. The process then proceeds to Step S104.

(1) When the print pattern acquired at Step S102 corresponds to printing one sheet, the system controller 121 predicts that the staple using possibility will be “Low” because the staple using possibility in the item 502 associated with the “printing only one sheet” in item 501 of the table 500 is “Low”.

(2) When the print pattern acquired at Step S102 corresponds to for example printing 5 copies of page 1, the system controller 121 predicts that the staple using possibility will be “Low” because the staple using possibility in the item 502 associated with the “printing sheets having the same contents” in the item 501 of the table 500 is “Low”.

(3) When the print pattern acquired at Step S102 corresponds to for example printing 3 copies of 15 pages—3 copies of pages 1 to 15—, the system controller 121 predicts that the staple using possibility will be “Low” because the staple using possibility in the item 502 associated with the “printing sheets whose number obtained by printing one copy of specific pages exceeds the maximum number of sheets that can be stapled” in item 501 of the table 500 is “Low”.

(4) When the print pattern acquired at Step S102 corresponds to for example printing 3 copies of 8 pages—3 copies of pages 1 to 8—, the system controller 121 predicts that the staple using possibility will be “High” because the staple using possibility in the item 502 associated with the “printing copies whose number of sheets per copy is up to the maximum number of sheets that can be stapled” in item 501 of the table 500 is “High”.

(5) When the print pattern acquired at Step S102 corresponds to for example printing, of ten pages, 3 copies of pages 1 to 5 and 5 copies of pages 6 to 10, the system controller 121 predicts that the staple using possibility will be “High” because the staple using possibility in the item 502 associated with the “printing sheets whose number obtained by printing one copy of specific pages does not exceeds the maximum number of sheets that can be stapled” in item 501 of the table 500 is “High”.

(Step S104)

The system controller 121 determines whether or not the sleep transition time needs to be extended.

In this case, when the staple using possibility predicted at Step S103 corresponds to the items (1) to (3), the system controller 121 determines that the sleep transition time need not be extended (Step S104: No). The process then proceeds to Step S105.

In contrast, when the staple using possibility predicted at Step S103 corresponds to the item (4) or (5), the system controller 121 determines that the sleep transition time needs to be extended (Step S104: Yes). The process then proceeds to Step S110.

(Step S105)

The system controller 121 does not switch the first time that is sleep transition time having been set.

In this case, the system controller 121 does not instruct the power management section 120 to switch the sleep transition time. The process then proceeds to Step S106.

(Step S106)

The system controller 121 determines whether or not printing is completed.

In this case, when no print completion notification from the printer controller 112 exists, the system controller 121 determines that printing is not completed (Step S106: No).

In contrast, when the print completion notification from the printer controller 112 exists, the system controller 121 determines that the printing is completed (Step S106: Yes).

The process then proceeds to Step S107.

(Step S107)

The system controller 121 determines whether or not a new print start instruction exists.

In this case, the system controller 121 determines that no new print start instruction exists when notification (second notification) does not exist (Step S107: No). Here, the second notification indicates that a print job including a print instruction from the communication controller 114 has been received. The process then proceeds to Step S108.

In contrast, the system controller 121 determines that the new print start instruction exists when the second notification (indicates that the print job including the print instruction from the communication controller 114 has been received) exists (Step S107: Yes). The process then returns to Step S102.

Note that when the process returns to Step S102, the system controller 121 again instructs the image processing section 117 to perform image processing of print data of the print job, and again instructs the printer controller 112 to perform print processing based on data on which the image processing by the image processing section 117 has been performed.

(Step S108)

The system controller 121 determines whether or not the first time is reached.

In this case, when determining at Step S107 that no new print start instruction exists after printing is complete at Step S106, the system controller 121 checks an unillustrated internal timer and determines that the first time has not been reached (Step S108: No). The process then returns to Step S107.

In contrast, when determining at Step S107 that no new print start instruction exists after the printing is complete at Step S106, the system controller 121 checks the unillustrated internal timer and determines that the first time has been reached (Step S108: Yes). The process then proceeds to Step S109.

(Step S109)

The system controller 121 performs shift control to the sleep mode.

In this case, the system controller 121 performs control of the power management section 120 so that the power management section 120 shifts to the sleep mode.

At this moment, the power management section 120 stops supplying power to the print mechanism section having the illustrated photosensitive drum and the like in the printer section 102, part of the panel section 105 of the MFP 100, and the post-processing device 200.

(Step S110)

The system controller 121 performs switch control from the first time to the second time according to the print pattern. The process then proceeds to Step S111.

In this case, in the case where the print pattern corresponds to for example printing 3 copies of pages 1 to 8 as the item (4) at Step S103 described above, the system controller 121 sets the second time to 4 minutes obtained by adding 3 minutes to the first time that is set to for example 1 minute, and causes the power management section 120 to switch the first time with 4 minutes (second time). That is, in the case where stapling is performed by the inner type post-processing device 200, the user is required to separate printed matter into batches and then separately insert each of the separated batches (i.e., sheets of paper) into the insertion slot 201 of the post-processing device 200. That is, if the number of copies to be stapled is for example 3, 3 minutes are required as a result of separation time required per copy being regarded as for example 1 minute. However, in the case where no new print start instruction exists after the printing is completed, the waiting time until reaching the first time is reduced. Hem the first time is sleep transition time that has been set as for example 1 minute. The system controller 121 accordingly sets the second time to 4 minutes obtained by adding, to the first time, 3 minutes corresponding to for example 3 that is the number of copies to be stapled, and causing the power management section 120 to switch the first time with 4 minutes (second time). This enables power to be supplied to the post-processing device 200 until each of the 3 copies (each batch of sheets of paper) has been stapled.

In addition, in the case where the print pattern corresponds to printing, of 10 pages, 3 copies of pages 1 to 5 and 5 copies of pages 6 to 10 as the item (5) at Step S103, the system controller 121 sets the second time to 9 minutes obtained by adding 8 minutes to the first time having been set to for example 1 minute, and causes the power management section 120 to switch the first time with 9 minutes (second time). That is, in the abovementioned separation of the printed matter into batches, when the number of copies of pages 1 to 5 is 3 and the number of copies of pages 6 to 10 is 5 for example, 8 minutes may be needed by regarding time required for separation per copy (batch) as for example 1 minute. Further, as described above, the waiting time until reaching the first time that is the sleep transition time after the printing is completed is reduced. Therefore, the system controller 121 sets the second time to 9 minutes obtained by adding, to the first time, 8 minutes corresponding to for example 8 that is the number of copies to be stapled, and causes the power management section 120 to switch the first time with 9 minutes (second time). This enables power to be supplied to the post-processing device 200 until each of the 8 copies (each batch of sheets of paper) has been stapled.

Note that although time added per copy is regarded as 1 minute in this embodiment, the time added per copy may be varied according to the number of sheets per copy. That is, when the number of sheets per copy is for example not more than 3, the time added per copy may be 30 seconds. When the number of sheets per copy is for example more than 3 and not more than 5, the time added per copy may be 40 seconds. When the number of sheets per copy is for example more than 5 and not more than 7, the time added per copy may be 50 seconds. When the number of sheets per copy is for example more than 7 and not more than 10, the time added per copy may be 60 seconds.

(Step S111)

The system controller 121 determines whether or not printing is completed.

In this case, when no print completion notification from the printer controller 112 exists, the system controller 121 determines that the printing is not completed (Step S111: No).

In contrast, when the print completion notification from the printer controller 112 exists, the system controller 121 determines that the printing is completed (Step S111: Yes). The process then proceeds to Step S112.

(Step S112)

The system controller 121 determines whether or not a new print start instruction exists.

In this case, when no second notification (indicating that the print job including the print instruction from the communication controller 114 has been received) exists, the system controller 121 determines that no new print start instruction exists (Step S112: No). The process then proceeds to Step S113.

In contrast, when the second notification (indicating that the print job including the print instruction from the communication controller 114 has been received) exists, the system controller 121 determines that the new print start instruction exists (Step S112: Yes). The process then returns to Step S102.

Note that when the process returns to Step S102, the system controller 121 again instructs the image processing section 117 to perform image processing of print data of the print job, and again instructs the printer controller 112 to perform print processing based on data on which the image processing by the image processing section 117 has been performed.

(Step S113)

The system controller 121 determines whether or not a second time is reached.

In this case, when determining at Step S112 that no new print start instruction exists after printing is complete at Step S111, the system controller 121 checks the unillustrated internal timer and determines that the second time is not reached (Step S113: No). The process then returns to Step S112.

In contrast, when determining at Step S112 that no new print start instruction exists after printing is complete at Step S111, the system controller 121 checks the unillustrated internal timer and determines that the second time has been reached (Step S113: Yes). The process then proceeds to Step S114.

(Step S114)

The system controller 121 resets the second time to the first time.

In this case, the system controller 121 causes the power management section 120 to switch the second time with the first time. The process then proceeds to Step S109.

When the process proceeds to Step S109, the power management section 120 stops supplying power to the print mechanism section having the unillustrated photosensitive drum and the like in the printer section 102, part of the panel section 105 of the MFP 100, and the post-processing device 200.

Note that in order that the first time is switched with the second time at Step S110 described above, setting the time added per copy to for example 1 minute may reduce energy savings because the sleep transition time is unnecessarily prolonged depending on the number of copies to be printed. That is, when the number of copies is for example 60, the second time becomes 61 minutes obtained by adding, to the first time, 60 minutes corresponding to for example 60 that is the number of copies to be stapled. In the case where the sleep transition time is prolonged depending on the number of copies to be printed in this way, when the number of copies to be printed is for example a predetermined number (for example 5) or more, time to be added is set to constant time (for example 5 minutes). In this case, the second time is to be changed to 6 minutes. However, the second time is changed by adding the constant time (for example 5 minutes) to the first time every time a staple operation is confirmed even within constant time (for example 20 seconds) just before 6 minutes are reached. This configuration prevents the sleep transition time from being unnecessarily prolonged when the stapling operation is complete early even in the case where the number of copies to be printed is the predetermined number (for example 5) or more.

Further, in order that the first time is switched with the second time at step S110 described above, user movement time (predetermined time) to the MFP 100 may be considered. That is, when the user causes the user terminal 300 to transmit a print job including a print instruction to the MFP 100, it is predicted that the user will move to the MFP 100 in anticipation of printing completion. In this case, the second time may be determined according to the print pattern by further adding, to the first time, predetermined user movement time to the MFP 100.

Although the sleep transition process according to the print pattern of the print job is described in the above-described procedure, staples may be used as described above also in the case of copying. In the case of copying, when a copy print pattern corresponds to the items (1) to (3) at step S104 described above, it may be determined that the sleep transition time need not be extended. When the copy print pattern corresponds to the items (4) and (5), it may be determined that the sleep transition time needs to be extended.

In the above-described procedure, when the second time is reached, the power management section 120 enters the sleep mode and stops supplying power to the print mechanism section having the unillustrated photosensitive drum and the like in the printer section 102, part of the panel section 105, and the post-processing device 200. However, the present disclosure is not limited to this. When the first time is reached, the power management section 120 may stop supplying power to the print mechanism section having the unillustrated photosensitive drum and the like in the printer section 102, and part of the panel section 105. When the second time is reached, the power management section 120 may stop supplying power to the post-processing device 200. This case enables reduction in power used by the MFP 100 because the sleep mode is shifted to when the first time is reached after printing is complete.

Although it is assumed that the post-processing device 200 is energized by power supplied from the MFP 100 in the above-described procedure, the process of switching the first time with the second time may be performed only on the post-processing device 200 in the case where the post-processing device 200 is energized by power supplied from the external power supply. This case enables reduction in power used by the MFP 100 like above-described configuration because the sleep mode is shifted to when the first time is reached after printing is complete.

As described above, in the present embodiment, the manual type post-processing device 200 attaches sheets of paper together using one or more staples, and the power management section 120 configured to supply power to the post-processing device 200 shifts from the normal mode to the power saving mode when no operation exists within the first time. The system controller 121 predicts whether possibility of using the one of more staples at this moment will be high or low based on predetermined reference including the print pattern of the print job and the processing ability of the post-processing device 200. The system controller 121 then causes the power management section 120 to switch the first time with the second time longer than the first time when predicting that the possibility of using the one or more staples will be high, and does not switch the first time with the second time when determining that the possibility of using the one or more staples will be low.

Thus, the system controller 121 predicts whether the possibility of using the one or more staples will be high or low based on the predetermined reference including the print pattern of the print job and the processing ability of the post-processing device 200. It is therefore possible to minimize the influence on energy savings by appropriately switching the first time with the second time even in the case where the post-processing device 200 is installed.

In addition, since the system controller 121 appropriately switches the first time with the second time, power supply from the MFP 100 to the post-processing device 200 being stopped is avoided while printed matter is being separated into batches. This makes a rest operation from the sleep mode to the normal mode unnecessary. It is therefore possible to reduce waiting time required for resetting to the normal mode, thereby improving operability of the post-processing device 200.

The embodiment of the present disclosure has been described above with reference to the drawings (FIGS. 1 to 4B). Note that the present disclosure is not limited to the above-described embodiment, but is applicable to various aspects without departing from the scope of gist thereof. Furthermore, variations may be formed by appropriately combining elements of configuration disclosed in the above embodiment. For example, some of the elements of configuration disclosed in the embodiment may be removed. In addition, elements of configuration from different embodiment examples may be appropriately combined.

What is claimed is:

1. An image forming apparatus, comprising:
a manual type post-processing device configured to attach sheets of paper together using one or more staples;
a power management section configured to supply power to the post-processing device, and shift from a normal mode to a power saving mode when no operation exists within first time, and
a system controller configured to predict whether possibility of using the one or more staples will be high or low based on whether or not at least one of two factors satisfies a predetermined condition, the two factors including a print pattern of a print job and processing ability of the post-processing device, wherein
the system controller causes the power management section to switch the first time with second time longer than the first time when predicting that the possibility of using the one or more staples will be high, and does not switch the first time with the second time when predicting that the possibility of using the one or more staples will be low.

2. The image forming apparatus according to claim 1, wherein
the system controller predicts that the possibility of using the one or more staples will be high when the print pattern corresponds to printing copies whose number of sheets per copy is within the processing ability of the post-processing device, or printing sheets whose number obtained by printing one copy of specific pages does not exceed the processing ability of the post-processing device.

3. The image forming apparatus according to claim 1, wherein
the system controller predicts that the possibility of using the one or more staples will be low when the print pattern corresponds to printing only one sheet, when printing sheets having the same contents, or when printing sheets whose number obtained by printing one copy of specific pages exceeds the processing ability of the post-processing device.

4. The image forming apparatus according to claim 1, wherein
when determining that the first time needs to be switched with the second time, the system controller determines the second time so that the second time includes constant time required in preparation for attaching the sheets of paper together using the one or more staples.

5. The image forming apparatus according to claim 1, wherein
when receiving the print job via a network and then predicting that the possibility of using the one or more staples will be high, the system controller determines the second time so that the second time includes predetermined movement time until printed matter is received.
